(19) United States
(12) Patent Application Publication
(10) Pub. No.: US 2006/0225041 A1
(43) Pub. Date: Oct. 5, 2006

(54) Method for testing modified user documentation software for regressions

(75) Inventor: Laura Lee Girolami-Rose, Raleigh, NC (US)

Correspondence Address: DUKE W. YEE, YEE & ASSOCIATES, P.C., P.O. BOX 802333, DALLAS, TX, 75380, US

(73) Assignee: International Business Machines Corporation, Armonk, NY (US)

(21) Appl. No.: 11/098,286

(22) Filed: Apr. 4, 2005

(51) Int. Cl. G06F 9/44

(52) U.S. Cl. 717/124

(57) ABSTRACT

An improved method and system is provided for performing regression tests on modifications made to user help documentation software. In the method, expected results based on the anticipated effects of proposed modifications are compared with the actual results detected after the modifications have been made. In one embodiment, a set of expected results is prepared, wherein the set comprises results expected when specified changes are implemented in a prior version of the specified software. Each of the specified changes is then implemented, to produce a modified version of the specified software. The modified version is monitored, to determine actual results caused by the specified changes, and the expected results are compared with the actual results, to detect variances therebetween. Usefully, an automated software tool is configured to rapidly extract specified user help elements from the modified user documentation software.

### BACKGROUND OF THE INVENTION

1. Field of the Invention

The invention disclosed and claimed herein generally pertains to a method and system for testing a modified version of on-line user documentation software for regressions, that is, for unexpected results caused by the modifications. More particularly, the invention pertains to a method of the above type wherein content changes that are expected from proposed software modifications are compared with actual content changes observed or detected after the modifications have been made. Even more particularly, the invention pertains to a method of the above type wherein an automated tool may be used to rapidly search the documentation for individual software help elements that were not expected to be changed by the modifications, but were changed. As used herein the term “user documentation software” means any form of on-line user documentation including on-line help and links to the Internet help sites.

2. Description of Related Art

User documentation typically has an essential role in enhancing the usability of software applications. Documentation software that provides on-line help, including links to Internet help sites, may be particularly important for application users. Accordingly, it is generally necessary to verify that on-line help links in user documentation are available, connected and working. As used herein, user documentation includes on-line manuals, tutorials, help messages and related web sites, though it is not necessarily limited thereto. The on-line help information in user documentation usefully comprises software elements such as pop-up windows, strings, class objects and user interface (UI) information. Strings may be messages associated with a web page that provide links to other web pages. Class objects may include tags, buttons and the like. The UI information generally is help related information that resides at a local user computer.

User help documentation software, as described above, will frequently need to be updated or modified, such as to provide new features or to correct problems. For example, it may be necessary to fix a bug or other defect that has been discovered in a software help element of the type described above. Those of skill in the art are, of course, very skilled in developing bug fixes and software modifications. Accordingly, the results expected from particular modifications can generally be predicted with a high degree of accuracy. However, because the related technology is so complex, software modifications may sometimes produce results that are not expected. Moreover, while some of the unexpected results will be acceptable or of no consequence, others will present significant problems. Thus, the process of developing modifications for user help documentation of the above type generally must include regression testing.

In regression testing, newly modified software must be tested or analyzed, to determine whether its operation produces unexpected results or effects that will cause problems, or is otherwise not acceptable. It would be very useful if efficiency in performing regression tests on modifications made to user documentation software could be significantly improved. This would enable undesirable actual results occurring in the modified software to be more readily detected, so that corrections could be made more quickly.

It would also be very beneficial if regression testing procedures could be carried out using an automated tool for rapidly searching software documents, in order to identify user help elements of interest. Previously, regression testing has generally relied on manual techniques, which have often been found to be error prone. Also, because of the substantial time required for manual testing, it is very common when using this approach to perform tests only on selected samples of the modified documentation. It is anticipated that these deficiencies can be overcome by using automated regression testing.

### BRIEF SUMMARY OF THE INVENTION

The invention is generally directed to an improved method and system for performing regression tests on modifications made to user help documentation software. The invention enables expected changes in software content, based on the anticipated effects of proposed modifications, to be readily compared with the content changes that are actually detected or observed, after the modifications have been made. Embodiments of the invention may also make use of an automated software tool configured to rapidly acquire specified user help elements from the modified software, as described hereinafter in further detail. One useful embodiment of the invention is directed to a method for testing a modified version of specified user documentation software for regressions. The method includes the step of preparing a set of expected results, wherein the set comprises one or more results that are expected to occur when a number of specified changes are implemented in a prior version of the specified software. The method further includes actually implementing each of the specified changes in the prior version, to produce the modified version of the specified software. The modified version is then monitored, to determine the actual results caused by implementing the specified changes. The expected results are compared with the actual results, to detect variances therebetween.

### BRIEF DESCRIPTION OF THE SEVERAL VIEWS OF THE DRAWINGS

The novel features believed characteristic of the invention are set forth in the appended claims. The invention itself, however, as well as a preferred mode of use and further objectives and advantages thereof, will best be understood by reference to the following detailed description of an illustrative embodiment when read in conjunction with the accompanying drawings, wherein:

FIG. 1 is a schematic diagram illustrating a network having a server that is operable to implement an embodiment of the invention.

FIG. 2 is a block diagram showing components of the server of FIG. 1.

FIG. 3 is a schematic diagram illustrating principal features of an embodiment of the invention.

FIGS. 4 and 5 are flow charts respectively depicting alternative embodiments of the invention.

### DETAILED DESCRIPTION OF THE PREFERRED EMBODIMENTS

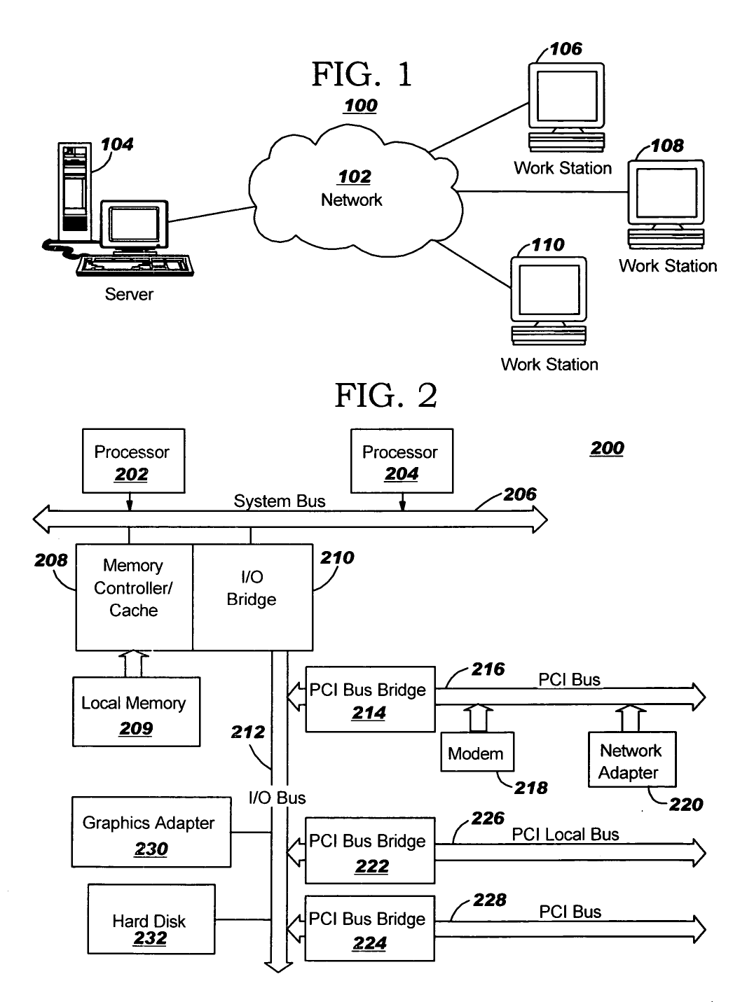

Referring to FIG. 1, there is shown a distributed data processing system 100 that includes a network 102. Network 102 interconnects a server 104 with a number of user computers or work stations 106-110, wherein server 104 provides data to the user work stations, such as boot files, operating system images and applications. Server 104 also provides user documentation associated with respective applications, wherein the user documentation contains on-line help information. Server 104 is adapted to develop successive versions of the user documentation, and is further adapted to implement embodiments of the invention, as described hereinafter.

In FIG. 1, distributed data processing system 100 usefully comprises the Internet, with network 102 representing a worldwide collection of networks and gateways that use the TCP/IP suite of protocols to communicate with one another. At the heart of the Internet is a backbone of high-speed data communication lines between major nodes or host computers consisting of thousands of commercial, government, education, and other computer systems that route data and messages. Alternatively, distributed data processing system 100 may be implemented as one of a number of other types of networks such as, for example, an intranet or a local area network. FIG. 1 is intended as an example and not as an architectural limitation for the processes of the present invention.

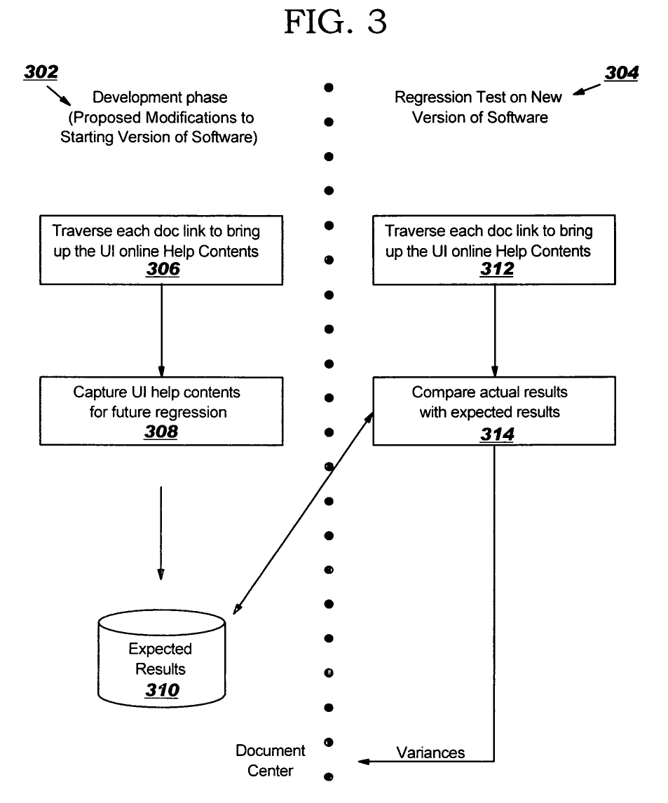

Referring to FIG. 2, there is shown a block diagram of a data processing system which may be used as the server 104 depicted in FIG. 1. Data processing system 104 may be a symmetric multiprocessor (SMP) system including a plurality of processors 202 and 204 connected to system bus 206. Alternatively, a single processor system may be employed. Also connected to system bus 206 is a memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted. Peripheral component interconnect (PCI) bus bridge 214 connected to I/O bus 212 provides an interface to PCI local bus 216. A number of modems 218-220 may be connected to PCI bus 216. Typical PCI bus implementations will support four PCI expansion slots or add-in connectors. Communications links to network computers 106-110 in FIG. 1 may be provided through modem 218 and network adapter 220 connected to PCI local bus 216 through add-in boards. Additional PCI bus bridges 222 and 224 provide interfaces for additional PCI buses 226 and 228, from which additional modems or network adapters may be supported. In this manner, server 104 allows connections to multiple network computers. A memory mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

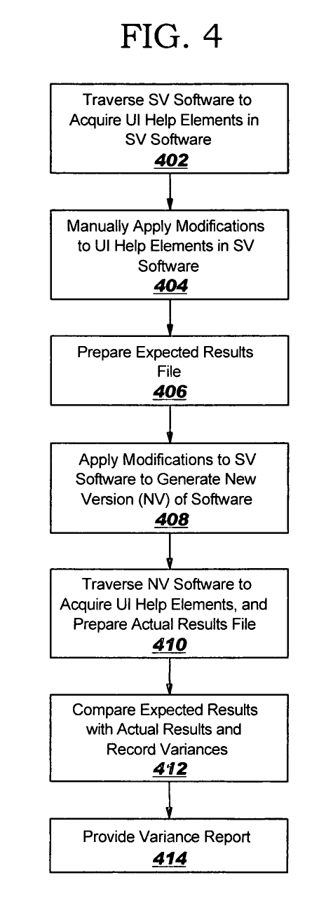

FIG. 3 shows an embodiment of the invention that generally comprises two cycles or phases. During a development phase 302, proposed modifications are developed to the then currently existing version of particular user documentation software. The user documentation software includes on-line help elements of the type described above, such as class objects, strings and UI information. Modifications may be developed, for example, to fix bugs or defects that were previously discovered in some of the on-line help elements.

During a regression test phase 304, expected content of the user documentation is compared with actual content, using an automated tool as described hereinafter in further detail. “Expected content” refers to changes that are expected or anticipated to occur in the user documentation, if the proposed modifications are made thereto. “Actual content” refers to changes that are actually observed or detected in a new version of the software, produced by implementing the modifications into the software. The regression test phase 304 detects and provides notice of all differences or variances between expected content changes or results and the respectively corresponding actual content changes.

After the proposed software modifications have been developed, an automated software test tool is operated to rapidly traverse the user documentation, including on-line help content that is identified by links in the user documentation. As it traverses the documentation, the tool collects on-line software help elements, such as class objects, strings, and UI information. This task is illustrated in FIG. 3 by function block 306, wherein the on-line help elements acquired by the automated software tool are collectively referred to as UI on-line help contents. Function block 308 shows the UI help contents being acquired or captured for use in the regression test phase, and more particularly for use in providing a set of results that are expected from the proposed software modifications. The automated software test tool may usefully comprise a product known commercially as IBM Rational Functional Tester, and may be implemented using components located at server 104. Server 104 may also be used to display and review acquired on-line help elements, and to place them in a storage 310 as “expected results of help element modifications” files.

When the software modifications are applied to or implemented in the previously current software version, the new version is produced and becomes available for regression testing. As shown by function block 312 of FIG. 3, the first step is to operate the automated tool to traverse the new version of the user documentation, in accordance with the same pattern or “test scripts” used in traversing the prior version of the software. Thus, the tool will collect or acquire the same set of on-line software help elements as acquired previously, during the development phase, except that at least some of the newly acquired elements will have changes due to the software modifications. Accordingly, this set of elements contains the actual results of the modifications.

Function block 314 of FIG. 3 shows these actual results compared with the expected results, from storage 310, in order to provide a record of all variances that are detected or observed therebetween. For example, it may be expected that the software modifications will provide a particular class object with a new and beneficial feature. However, the corresponding actual result could be that the particular class object in fact does not have the new feature. Alternatively, the actual result could be that the particular object does have the expected new feature, but has also acquired some new characteristics, or has lost some desirable characteristics or features that it had in the prior software version.

The task of comparing the expected and actual results, and generating a variance record thereof, may likewise be carried out by implementing a software application at the server 104. The completed variance record may be sent to a documentation center, library, or other depository.

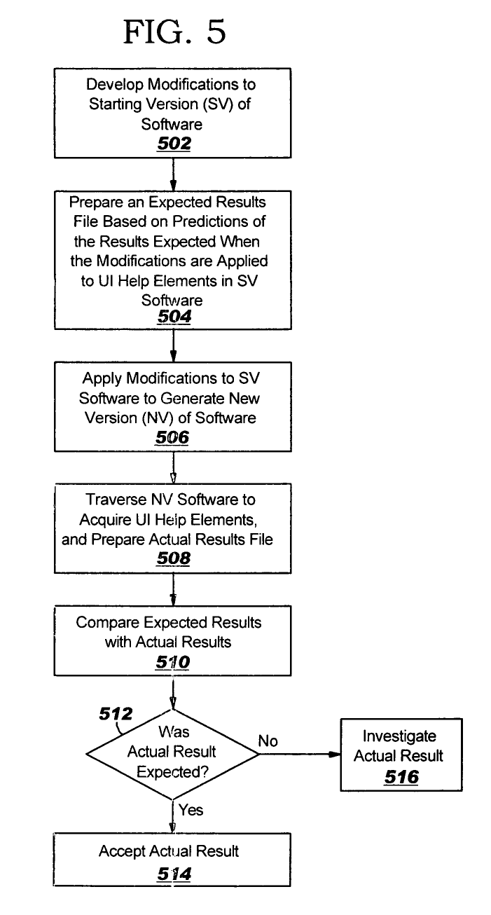

FIG. 4 is a flow chart showing respective steps of an embodiment of the invention in further detail. The initial step of the procedure shown in FIG. 4, as indicated by function block 402, is to acquire or collect individual on-line UI help elements contained in the then current version of specified user documentation software, of the type described above. This version is also referred to herein as the starting version or prior version. Respective UI help elements are usefully acquired using the automated software tool described above in connection with FIG. 3. It is anticipated that modifications will be made to UI help elements such as class objects, strings and the like, although modifications may be directed to other components of the software as well. After respective UI help elements in the starting version of the software have been acquired, proposed modifications are applied to them, as shown by function block 404. The modifications are made manually, for example by a user operating a work station, to modify UI help elements on an individual basis. After respective modifications are completed, they are used to prepare an expected results file, as shown by function block 406. Since this file is derived from UI help elements that have been modified manually by the new software modifications, it can be referred to as the “gold file”.

Referring further to FIG. 4, following preparation of the expected results file, the software modifications are implemented in the starting version of the documentation software, thereby generating a new version (NV) of the software. This is indicated by function block 408. As shown by function block 410, NV software is traversed to acquire the modified UI help elements, and an actual results file is prepared therefrom. Function block 412 shows the actual results of modifying respective UI help elements being compared with the corresponding expected results. Variances between the actual and expected results are incorporated into a variance report, as shown by function block 414.

FIG. 5 shows respective steps of a procedure comprising an alternative embodiment of the invention. As indicated by function block 502, the first step of the procedure is to traverse the starting version of specified user documentation software, to collect or acquire the UI help elements therefrom. Again, the automated software tool is used to collect the UI help elements. The collected UI help elements, which have not been modified, are then used as an expected results file, as shown by function block 504.

Referring further to FIG. 5, function blocks 506 and 508 show that the software modifications are applied to or implemented in the starting software, to generate the new version (NV) of the software. The NV software is then traversed to acquire actually modified UI help elements, and an actual results file is prepared therefrom. Function block 510 shows the actual results of modifying respective UI help elements being compared with the corresponding expected results.

FIG. 5 further shows a decision block 512, provided to determine whether a detected actual result was or was not expected, as indicated by the expected or predicted result corresponding to the same UI help element. If the comparison at function block 510 indicates that the actual result in fact was the same as the corresponding expected result, the result is accepted for the NV software, as shown by function block 514. However, if an actual result was not expected, it must be investigated, as indicated by function block 516. Investigation is necessary to determine whether the unexpected actual result will require further modification or correction, before it can be accepted for use in the new version of the software.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for testing a modified version of specified user documentation software for regressions, said method comprising the steps of:
preparing a set of expected results, wherein said set comprises one or more results that are expected to occur when a number of specified changes are implemented in a version of said specified software that is prior to said modified version;
implementing each of said specified changes in said prior version to produce said modified version of said specified software;
selectively processing said modified version of said specified software to determine actual results caused by implementing said specified changes in said prior version; and
comparing said expected results with said actual results to detect variances therebetween.

2. The method of claim 1, wherein:
said user documentation software comprises software elements that are selected from a group including class objects, strings and UI information.

3. The method of claim 2, wherein:
said specified changes are applied to at least some of said software elements, and said processing step comprises operating a specified automated tool to traverse said modified version of said specified software, in order to collect each of said software elements from said modified software for display and analysis.

4. The method of claim 1, wherein said step of preparing said set of expected results comprises:
manually implementing each of said specified changes in said software elements in said prior version of said specified software; and
preparing said set of expected results from said software elements in which said changes have been manually implemented.

5. The method of claim 1, wherein:
said set of expected results is prepared from respective unmodified software elements contained in said prior version of said specified software.

6. The method of claim 5, wherein:
said comparing step comprises accepting for use in said modified version each actual result that is substantially identical to one of said expected results, and selectively investigating each actual result that is not substantially identical to one of said expected results.

7. The method of claim 1, wherein:
said specified user documentation software comprises on-line help documentation.

8. The method of claim 1, wherein:
said variances found between said expected and actual results are incorporated into a report.

9. A computer program product in a computer readable medium for testing a modified version of specified user documentation software for regressions, said computer program product comprising:
first instructions for preparing a set of expected results, wherein said set comprises one or more results that are expected to occur when a number of specified changes are implemented in a version of said specified software that is prior to said modified version;
second instructions for implementing each of said specified changes in said prior version to produce said modified version of said specified software;
third instructions for selectively processing said modified version of said specified software to determine actual results caused by implementing said specified changes in said prior version; and
fourth instructions for comparing said expected results with said actual results to detect variances therebetween.

10. The computer program product of claim 9, wherein:
said user documentation software comprises software elements that are selected from a group including class objects, strings and UI information.

11. The computer program product of claim 10, wherein:
said specified changes are applied to at least some of said software elements, and said processing step comprises operating a specified automated tool to traverse said modified version of said specified software, in order to collect each of said software elements from said modified software for display and analysis.

12. The computer program product of claim 9, wherein said set of expected results is prepared by:
manually implementing each of said specified changes in said software elements in said prior version of said specified software; and
preparing said set of expected results from said software elements in which said changes have been manually implemented.

13. The computer program product of claim 9, wherein:
said set of expected results is prepared from respective unmodified software elements contained in said prior version of said specified software.

14. The computer program product of claim 13, wherein:
said comparing step comprises accepting for use in said modified version each actual result that is substantially identical to one of said expected results, and selectively investigating each actual result that is not substantially identical to one of said expected results.

15. The computer program product of claim 9, wherein:
said specified user documentation software comprises on-line help documentation.

16. The computer program product of claim 9, wherein:
said variances found between said expected and actual results are incorporated into a report.

17. Apparatus for testing a modified version of specified user documentation software for regressions, said apparatus comprising:
a data storage device for storing a set of expected results, wherein said set comprises one or more results that are expected to occur when a number of specified changes are implemented in a version of said specified software that is prior to said modified version;
a computer component operable to implement each of said specified changes in said prior version to produce said modified version of said specified software;
a first processor adapted to selectively process said modified version of said specified software to determine actual results caused by implementing said specified changes in said prior version; and
a second processor adapted to compare said expected results with said actual results to detect variances therebetween.

18. Apparatus of claim 17, wherein:
said specified changes are applied to selected user help software elements; and
said first processor operates a specified automated tool to traverse said modified version of said specified software, in order to collect each of said software elements from said modified software for display and analysis.

19. The apparatus of claim 17, wherein preparation of said set of expected results stored in said data storage device comprises:
manually implementing each of said specified changes in said software elements in said prior version of said specified software; and
preparing sid set of expected results from said software elements in which said changes have been manually implemented.

20. The apparatus of claim 17, wherein:
said set of expected results is prepared from respective unmodified software elements contained in said prior version of said specified software; and
said second processor is further adapted to accept for use in said modified version each actual result that is substantially identical to one of said expected results, and to selectively investigate each actual result that is not substantially identical to one of said expected results.
